(19) United States
(12) Patent Application Publication
(10) Pub. No.: US 2011/0067523 A1
(43) Pub. Date: Mar. 24, 2011

(54) Pedal shaft for bicycles

(76) Inventor: Giuseppe Marabeti, Palermo (PA) (IT)

(21) Appl. No.: 12/927,596

(22) Filed: Nov. 17, 2010

(30) Foreign Application Priority Data
May 23, 2008 (IT) PA2008A000018

(51) Int. Cl. B62M 3/00

(52) U.S. Cl. 74/594.1

(57) ABSTRACT

A pedal shaft for bicycles with elbow-shaped cams allows the dead centre of the pedaling motion to be cancelled out, thus resulting in more power with less exertion.

The present invention refers to a pedal shaft for bicycles which is particularly indicated for eliminating the inertia of the “dead centre”.

As is known, the functioning of a bicycle is determined by a system of levers. In fact, in the mechanical system known as a bicycle, the pedal shaft represents the first lever to which the cyclist applies force.

The pedal shaft, in the field of cycling, is an element with an elongated form which connects the central movement of the bicycle to the pedals.

When the pedals are located perfectly vertical, in this position the so-called ‘dead centre’ moment occurs, in which the pedal shafts do not generate enough power and the cyclist has to make an effort to surpass this point but without resulting in a pushing action on the wheel. This effort weighs down the muscles, which are fatigued by the irregularity of the movement.

The aim of the present invention is essentially to solve the problems of the commonly known technique, by overcoming the aforesaid drawbacks by means of a pedal shaft for bicycles able to cancel out the inertia of the dead centre, permitting the cyclist to generate power and resulting in a regular and effective pedaling motion, with less effort and greater speed.

A further aim of the present invention is to realise a pedal shaft for bicycles able to increase the force applied to the fulcrum without losing agility due to the wider movement.

A still further aim of the present invention is to realise a pedal shaft for bicycles which allows the reduction of muscle fatigue of the cyclist, in turn stimulating greater endurance.

A further but not final aim of the present invention is to realise a pedal shaft for bicycles which is easy to manufacture and works well.

These aims and others besides, which will better emerge over the course of the present description, are essentially achieved by means of a pedal shaft for bicycles, in accordance with the claims that follow.

Further characteristics and advantages will better emerge in the description of a preferred but not exclusive embodiment of a pedal shaft for bicycles according to the invention, provided in the form of a non-limiting example, with reference to the accompanying drawings, in which:

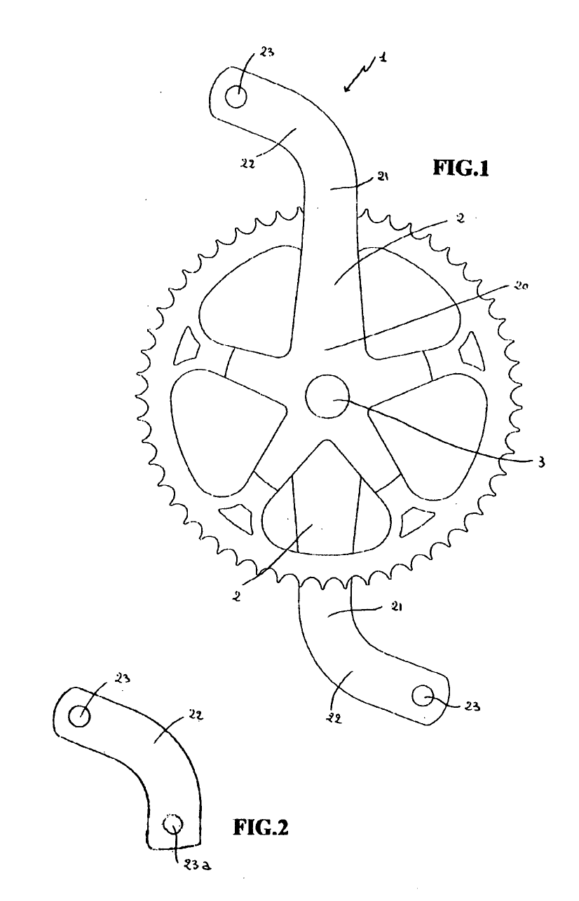

FIG. 1 shows, schematically, a pedal shaft for bicycles according to the present invention;

FIG. 2 shows, schematically, an clement of the pedal shaft in FIG. 1.

With reference to the aforesaid figures, in particular FIG. 1, 1 denotes the pedal shaft for bicycles as a whole, according to the present invention.

The pedal shaft for bicycles 1 in question is essentially constituted of an element with an elongated form 2 which features a first end 20 connected to the central movement 3 and the other end 21 endowed with a curvilinear cam section 22 with an elbow shape. In more detail, the cam section 22 features a minimum length of 50 mm.

In particular, the longer the cam section 22 is, the more one moves away from the “dead centre” with respect to the bicycle's axis of movement.

According to the present invention, the cam section 22 features a hole 23 into which a pedal is engaged.

Naturally, there are two pedal shafts present on a bicycle, one for each pedal, as shown in FIG. 1.

In agreement with the present invention, for bicycles already in use and available on the market, it is possible to modify the current pedal shafts by adding the cam section 22 to the end where the pedals are connected.

In fact, as shown in FIG. 2, the cam section 22 features a second hole 23a which, by means of fastening means, will permit a commonly known type of pedal shaft to mutually engage with the cam section 22 in such a way as to obtain the same configuration of the pedal shaft as in the present invention.

The pedal shaft according to the present invention is realized with steel, aluminium, any metal alloys, carbon fibre or even a sufficiently resistant plastic material.

The pedal shaft 1 according to the present invention is designed to switch from a resting condition, in which it is inactive and the pedals are stationary, to an operational condition, in which a cyclist, when pedaling, surpasses the dead centre with a regular pedaling motion, less effort and more speed.

After the predominantly structural description above, the operation of the invention in question will now be outlined.

When a cyclist is pedaling and, for example, the right-hand pedal arrives at the lower dead centre, the other pedal shaft is in the corresponding position to the upper dead centre but, due to the presence of the cam section 22, the pedal shaft is pushed forwards, surpassing the dead centre, therefore it is ready to generate power, thus resulting in a regular pedaling motion, with less effort and more speed, above all with racing bicycles and uphill. The same applies to the other pedal and pedal shaft thereof.

Thus the present invention achieves the aims set.

The pedal shaft for bicycles in question features great facility of use, permitting the cyclist to increase the force applied, thus resulting in a regular and effective pedaling motion which translates into more speed with less effort.

In particular, with the pedal shaft in question, the cyclist no longer has to make a further effort, in the form of a pushing action, to make the pedals surpass the dead centre, as occurs with the commonly known type of pedal shafts and all the force employed is directed on the wheels, with a more uniform output which weighs less on the muscles, which work with a constant and regular movement, resulting in greater endurance.

Advantageously, the pedal shaft permits an increase in the force applied to the fulcrum without losing agility due to the wider movement.

In addition to the above, the cam section taken separately, allows pedal shafts according to the commonly known technique to be modified, transforming them into those in the present invention.

A still further advantage is due to the fact that the pedal shaft proves easy to manufacture and works well.

Naturally, further modifications or variants may be applied to the present invention while remaining within the scope of the invention that characterises it.

1) Pedal shaft for bicycles characterised by the fact that the said shaft is essentially constituted of an element with an elongated form (2) which features a first end (20) connected to the central movement (3) and the other end (21), endowed with a curvilinear cam section (22) with an elbow shape, which features a minimum length of 50 mm, the said pedal shaft being designed to switch from a resting condition, in which it is inactive and the pedals are stationary, to an operational condition, in which a cyclist, when pedaling, surpasses the dead centre with a regular pedaling motion, less effort and more speed, thus resulting in more power with less exertion.

2) A pedal shaft for bicycles according to claim 1, characterised by the fact that the cam section (22) features a hole (23) in which a pedal is engaged.

3) A pedal shaft for bicycles according to claim 1, characterised by the fact that the cam section (22) features a second hole (23a) which, by means of fastening means, allows a commonly known type of pedal shaft to mutual engage with the cam section (22) in such a way that the same configuration of the pedal shaft is obtained as in the present invention.

4) A pedal shaft for bicycles according to claim 1, characterised by the fact that the said shaft is realised with steel, aluminium, any metal alloy, carbon fibre or a suitably resistant plastic material.
